(19) United States
(12) Patent Application Publication
(10) Pub. No.: US 2005/0039333 A1
(43) Pub. Date: Feb. 24, 2005

(54) Method for manufacturing steam turbines

(76) Inventor: Michael Wechsung, Ruhr (DE)

Correspondence Address: HARNESS, DICKEY & PIERCE, P.L.C., P.O.BOX 8910, RESTON, VA, 20195, US

(21) Appl. No.: 10/301,629

(22) Filed: Nov. 22, 2002

(30) Foreign Application Priority Data
Nov. 22, 2001 (EP) 01127841.3

(51) Int. Cl. B23P 15/04

(52) U.S. Cl. 29/889.2

(57) ABSTRACT

A method for manufacturing steam turbines includes the step of manufacturing a plurality of the same housings and/or turbine rotors in stock. Further, the active blade section of at least one turbine stage is defined separately for each turbine. This is done according to the flow profile and pressure specification for the respective turbine.

The present application hereby claims priority under 35 U.S.C. §119 on European patent application number EP 01127841.3 filed Nov. 22, 2001, the entire contents of which are hereby incorporated herein by reference.

### FIELD OF THE INVENTION

The invention generally relates to a method for manufacturing steam turbines. Preferably, it relates to one which extends along a respective turbine axis and comprises a housing and a turbine rotor for being rotatable mounted within the housing. More preferably, the turbine housing and turbine rotor include, along the turbine axis, two or more circumferential grooves for receiving turbine vanes and rotating turbine blades respectively.

### BACKGROUND OF THE INVENTION

Due to ever increasing demand on electrical power the time for installing new power plants and the flexibility of design and use of turbines are major constraints for turbine manufactures. In German published patent application DE 197 02 592 A1 an industrial steam-turbine housing design is described which allows a flexible adapting of customer needs regarding the extraction of steam under different pressure at certain locations at the steam turbine. The turbine housing includes an extraction section whose radial housing inter-wall is inclined in dependency on the next blade's position. The turbine housing is comprised of housing sections, in which the extraction section is arranged between an inflow section and an outflow-side transition section.

In WO 98/31923 A1 steam turbines having a variable mean reaction degree are disclosed allowing a higher flexibility in designing steam turbines. The steam turbine comprises a plurality of turbine stages provided along the turbine rotor, each turbine stage comprising a guide blade structure and an axially arranged rotating blade assembly thereafter. The mean reaction degree that can be reached in one turbine stage ranges from 5% to 70%, whereby the reaction degree of at least two turbine stages having a different value.

U.S. Pat. No. 6,213,710 relates to a method and an apparatus for a turbomachine with an outer casing and an inner casing or blade carrier for thrust compensation.

### SUMMARY OF THE INVENTION

It is an object of an embodiment of the invention to provide a method for reducing the delivery time of a steam turbine including a housing and a turbine rotor for being rotatable mounted within the housing.

With the forgoing and other objects in view there is provided, in accordance with an embodiment of the invention, a method for manufacturing steam turbines, with each steam turbine extending along a turbine axis and including a housing and a turbine rotor for being rotatable mounted within the housing. The turbine housing includes, along the turbine axis, two or more circumferential grooves for receiving turbine vanes. Further, the turbine rotor (or turbine shaft) includes, along the turbine axis, two or more circumferential grooves for receiving rotating blades. Each blade and vane have a respective root portion for mounting in the respective groove and have an active blade section. The groove in the housing may also serve for receiving a guide blade structure including a plurality of vanes. The method includes the steps of manufacturing a plurality of the same housings and/or turbine rotors on stock and defining the active blade section of at least one turbine stage separately for each turbine according to the specification, in particular specifications for the flow profile and pressure of the steam of each respective turbine.

An embodiment of the invention proceeds from the perception that in manufacturing steam turbines, the manufacturing of large turbine components like turbine rotor (turbine shaft) and turbine housings (turbine casings) is most time consuming and time critical. This is due to the fact that those components have to be precisely cast or welded and due to the dimensions and the restricted number of suppliers the time from placing an order to receiving the large components might be quite long.

Furthermore, as the time for building and starting operation of a new power plant needs to be shortened due to customers demands, an embodiment of the invention overcomes the problem of a possible delay of the construction of the power plant due to the long delivery time for large components of a steam turbine. By manufacturing a number of alike steam turbine components like turbine rotor and inner housing these components will be readily available for new power plants. As the components are all the like those individual features asked for by the customers with respect to power output, steam pressure, steam temperature, steam extraction etc can be fulfilled by defining the flow path of the steam individually for each steam turbine by adjusting the active blade section of vanes and blades. As large components of a steam turbine model series have the same circumferential grooves (the form of the grooves may vary within a steam turbine from stage to stage) for receiving rotating blades and turbine vanes it is possible to calculate, to define and to design the turbine blades and vanes in advance so that the specifications for each turbine can be fulfilled individually.

The flow path within the steam turbine having a given geometry according to the turbine rotor and turbine housing is defined by the active blade section of the turbine vanes and the turbine blades within every turbine stage. By adjusting the active blade section of at least one turbine stage separately for each turbine according to the flow profile and pressure specification for the respective turbine it is possible to use the same turbine housing and turbine shaft geometry (e. g. the same turbine model series) within a range of several MW electrical power output, in particular in the 200 MW to 400 MW range. Through an embodiment of the invention it is therefore not necessary within a certain range of electrical power output to produce different large turbine components, in particular turbine housing and turbine rotor for each new turbine. As the same housing and turbine rotor type can be used within a wide range of electrical power output for the turbine by defining the active blade sections of at least one turbine stage in advance the construction time of a power plant can be reduced by ordering a plurality of these large components. As such, these large components are almost available from stock.

In accordance with another feature, the active blade section of all turbine stages are adapted and designed in advance to meet the particular specification for each turbine respectively. Designing the active blade sections and calculating the flow path of the steam and the steam conditions within the steam turbine in advance enables those skilled in the art in designing the steam turbine to vary a number of parameters for defining and calculating the most suitable steam flow profile for a prespecified applications, e.g. a certain power plant. The method may be applied for steam turbines in newly built power plant as well as for replacement turbines in old power plants.

In accordance with a further feature, the active blade sections are adjusted by predetermining the blade angle, which is the angle between the leading edge and the flow direction of the steam, for each stage. By designing the active blade sections individually for each turbine the blade geometry can be defined independently both in a cross-section and along the blade axis according to the individual specifications for each turbine. As the grooves are for all turbines the same for each turbine the same root profiles and root portion for the blades and vanes and whenever applicable also the same shroud portion are used.

A turbine blade or vane may have in the cross-section the same profile all along its blade axis. Along the blade axis the cross-sectional profile may also have the same blade angle or the blade angle may change along the blade axis.

Furthermore the active blade section can be wound or can be bent and it may change its cross-sectional profile along the blade axis. For the person skilled in the art a number of methods for designing and calculating an active blade section are available, as for example mentioned in International application WO99/13199 A1. A simple and efficient way for adjusting the active blade section could be by using turbine blades and vanes having a constant blade angle and a constant cross-sectional profile along the blade axis whereby the blade angle as well as the cross-sectional profile may vary along the stages of the turbine.

In accordance with an added feature the steam turbines are preferably high pressure or medium pressure turbines. Embodiments of the invention may also be applied to low pressure turbines.

In accordance with an additional feature for turbines having an electrical output which differs from each other in a range of 200 MW to 400 MW while the same housing and/or turbine rotor is used. By using the same housing and/or turbine rotor and defining the active blade sections within the turbine in advance, it is possible to use the turbine blades and vanes having root portions which fit in the respective standard grooves of the housing and/or the rotor having the same root profile. So by using standard housings and/or standard rotors having the same grooves for receiving turbine vanes and/or turbine rotating blades it is possible by just varying the active blade sections for blades and vanes having standard root portions and as far as applicable standard shroud portions to adjust the electrical output or a turbine within a wide range of between 200 MW and 400 MW.

In accordance with yet another feature the active blade sections are chosen so that a thrust, in particular an axial thrust, imposed from steam flowing through the turbine on the turbine, in particular on the housing and/or on the turbine rotor remains the same for each turbine. The axial thrust imposed on turbine components may be a further constraint for adjusting and designing the active blade sections. By providing the same thrust or at least almost the same thrust within an allowable small range for all turbines it is assured that no individual constructual changes have to be applied on the turbine housing and/or turbine rotor which allows the use of same housing and rotor for turbines differing in electrical output in several MW, in particular several hundred MW.

Although embodiments of the invention is illustrated and described herein as embodied in a method for manufacturing steam turbines it is nevertheless not intended to be limited to the details shown, since various modifications and structural changes may be made therein without departing from the spirit of the invention and within the scope and range of the equivalents of the claims.

### BRIEF DESCRIPTION OF THE DRAWINGS

The method of an embodiments of the invention, however, together with additional objects and advantages thereof, will best understood from the following description of specific embodiments when read in conjunction with the accompanying drawings, wherein:

FIG. 1 shows a longitudinal-sectional view of a barrel type high pressure turbine;

FIG. 2 shows a longitudinal-sectional view of a rotating blade and

FIG. 3 shows a development of a blade ring with a cross-sectional view through a rotating blade perpendicular to the blade axis.

In the figures and drawings, components corresponding to one another of a respectively shown exemplary embodiment in each case have the same reference numeral. The drawings have been simplified in order to emphasise certain features.

### DETAILED DESCRIPTION OF THE PREFERRED EMBODIMENTS

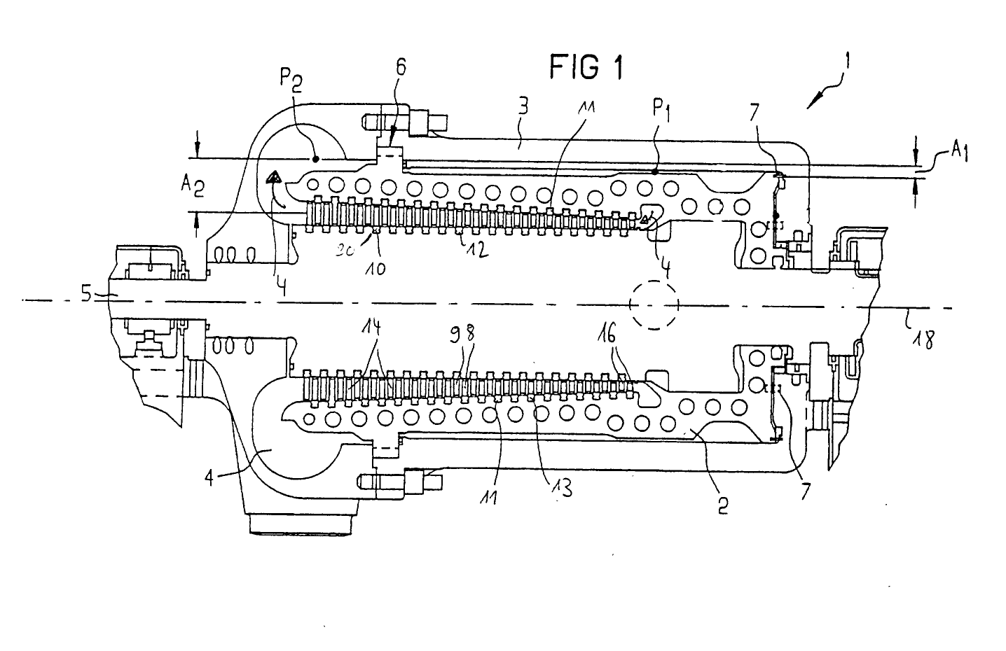

Referring now to the figures of the drawings in detail and first particularly to FIG. 1 thereof, there is shown in a longitudinal-sectional view a high pressure steam turbine 1 in pot-shaped construction. The high-pressure turbine 1 has an inner housing 2 (also called inner casing 2) and an outer casing 3 surrounding the inner housing 2. A turbine rotor 5 (also called shaft 5) extends along a turbine axis 18 and is rotatably mounted in the inner housing 2 for rotating around the turbine axis 18. The rotor 5 has along the turbine axis a number of circumferential grooves 10 each receiving a blade ring 20 with a plurality of alike rotating blades 9.

The inner housing 2 also has along the turbine axis 18 circumferentially extending grooves 11 receiving stationary turbine vanes 8 (for example in the form of a guide blade structure). Between two adjacent rings of turbine vanes 8 spaced axially apart a blade ring 20 of rotating blades 9 is located. A ring of vanes 8 forms together with that blade ring 20 of rotating blades 8 being next inline downstream the vane 8 a turbine stage 16. Each turbine vane 8 and each rotating blade 9 having a respective active blade section 14 along which the steam 4 flows. Steam 4 is guided and redirected by the active blade section 14 of the vanes 8 for efficiently flowing at and around the active blade section 14 of the rotating blades 9 thereby forcing the rotor 5 into rotation. Each rotating blade 9 has a root portion 12 which is inserted in a respective rotor groove 10 and to each vane 8 a respective root portion 13 is assigned, which is inserted in a respective housing groove 11.

The fluid 4, hot pressurised steam, flowing through the turbine 1 enters with an inlet pressure P1 and leaves the turbine 1 with an outlet pressure P2. The pressure difference between the inlet pressure and the outlet pressure leads to an axial thrust not only on the inner casing 2 but also on the turbine rotor 5. Depending on the type of vanes 8 and rotor blades 9, a differing pressure reduction in the steam 4 flowing through takes place there, and the pressure reduction has an effect on the shaft 5 and the inner casing 2.

On its outside, the inner casing 2 has an area A1 which is subjected to the inlet pressure P1. The axial thrust arising on the area A1 is superimposed on the axial force of the inner casing 2 which arises on the area A2 by pressure P2, as a result of which axial thrust compensation takes place at the latter. By virtue of the axial thrust compensation, a fixing 6 of the inner casing 2 relative to the outer casing 3 is subjected to small surface pressures. Area A1 of the outer part of the inner casing 2, which area transmits axial pressure, is bounded by a seal 7 disposed around the shaft 5, thereby limiting the pressure P1 acting on the area A1 which transmits the axial pressure. The use of the means 7 thus makes it possible precisely defined axial thrust compensation. Axial thrust compensation can take place not only at the inner casing 2 but also at the shaft 5, which for example is described in more detail in U.S. Pat. No. 6,213,710 to Remberg, the entire contents of which are hereby incorporated herein by reference. The axial thrust on the shaft 5 which occurs due to the pressure difference between the inlet pressure P1 and the outlet pressure P2 across the blades is at least partially compensatable.

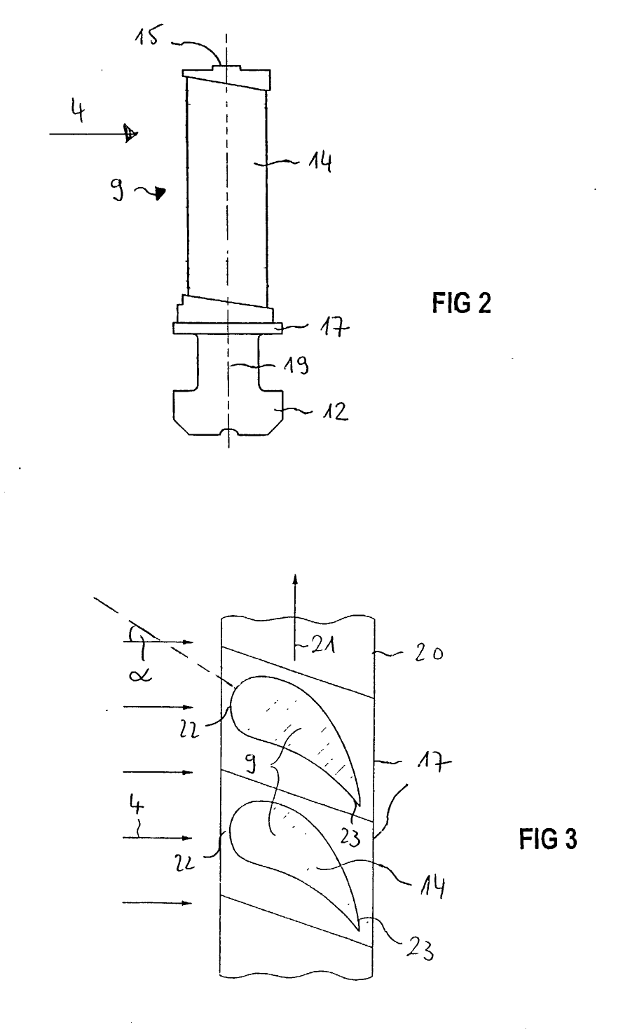

In FIG. 2 it is shown an exemplary embodiment of a rotating turbine blade 9 in a longitudinal sectional view along its blade axis 19. Along the blade axis 19 the rotating blade 9 has a root portion 12 with a hammer like profile. Next to the root portion 12 a root plate 17 separates the root portion 12 from an active blade section 14 being limited by a shroud portion 15. Hot steam 4 flows during the operation of the turbine 1 along the active blade section 14 perpendicular to the blade axis 19. With the hammer like root portion 12 the rotating blade 9 together with alike turbine blades 9 are inserted in a respective groove 10 of the rotor 5 to form a blade ring 20. The root plates 17 as well as the shroud 15 of adjacent blades 9 abut so that between adjacent active blade sections 14 a channel section is formed.

FIG. 3 shows a winding off of a blade ring 20 of rotating blades 9 inserted in a circumferential groove 10 of a rotor 5. Along the circumference direction 21 the blades 9 abut against their respective root plates 17. Each blade 9 includes a leading edge 22 and a trailing edge 23 downstream the leading edge 22. The active blade sections 14 forms a blade angle α with the flow direction of the steam 4 flowing through the turbine 1. The blade angle α of each respective blade ring 20 may vary for meeting the respective turbine specifications for steam flow, steam pressure, steam temperature, steam extractions etc. Different turbine stages 16 may also have different cross-sectional profiles of the active blade section 14. Also the form of the active blade sections 14 may vary.

A method of manufacturing steam turbines exists, whereby within a range of electrical power output standard turbine housings and/or standard turbine rotors are used each having standard grooves per stage for receiving turbine vanes and rotating blades respectively. Thus, it is possible to manufacture a plurality of these large components prior to receiving a specific turbine order, so that these large turbine components may be held on stock. The distinct specifications for a turbine, in particular electrical power output, steam temperature, steam pressure etc. will be fulfilled within the electrical power range for this specific type of turbine (turbine model series) by defining the active blade section of at least one turbine stage, in particular for all turbine stages. The root portions of rotating blades and those root portions assigned to turbine vanes or a guide blade structure of turbine vanes, in particular a half ring of turbine vanes, are also standardized for fitting in the respective grooves of the turbine rotor or turbine housing respectively. Furthermore if applicable for both turbine vanes and rotating blades also shroud portions are standardized.
1 steam turbine
2 inner housing, inner casing
3 outer housing, outer casing
4 steam
5 rotor, shaft
6 fixing
7 seal
8 vane
9 rotating blade
10 groove in rotor 5
11 groove in housing 2
12 root portion rotating blade
13 root portion vane
14 active blade section
15 shroud
16 turbine stage
17 root plate
18 turbine axis
19 blade axis
20 blade ring
21 circumference direction
22 leading edge
23 trailing edge
24 blade angle

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for manufacturing steam turbines, wherein each steam turbine extends along a turbine axis and includes a housing and a turbine rotor, being rotatably mounted within the housing, wherein the turbine housing includes along the turbine axis at least two circumferential grooves for receiving turbine vanes, and the turbine rotor includes along the turbine axis at lest two circumferential grooves for receiving rotating blades, each blade and vane including a respective root section for mounting in the respective groove and including an active blade section, the method comprising the steps of:
manufacturing a plurality of at least one of the same housings and turbine rotors in stock; and
defining the active blade section of at least one turbine stage separately for each turbine, according to a flow profile and pressure specification for the respective turbine.

2. The method according to claim 1, whereby for all turbine stages, the active blade sections are adapted to meet the particular specifications for each turbine, respectively.

3. The method according to claim 1, wherein the active blade sections are adjusted by predetermining the blade angle for each stage.

4. The method according to claim 1, wherein the steam turbines are at least one of high pressure and medium pressure turbines.

5. The method according to claim 1, wherein the turbines using at least one of the same housing and turbine rotor differ in a range of 200 MW to 400 MW electrical output.

6. The method according to claim 1, wherein the active blade sections are chosen so that a thrust imposed from steam flowing through the turbine on the turbine, remains almost the same for each turbine.

7. The method according to claim 1, wherein the active blade sections are chosen so that a thrust imposed from steam flowing through the turbine rotor, remains almost the same for each turbine.

8. The method according to claim 2, wherein the active blade sections are adjusted by predetermining the blade angle for each stage.

9. The method according to claim 2, wherein the steam turbines are at least one of high pressure and medium pressure turbines.

10. The method according to claim 2, wherein the turbines using at least one of the same housing and turbine rotor differ in a range of 200 MW to 400 MW electrical output.

11. The method according to claim 2, wherein the active blade sections are chosen so that a thrust imposed from steam flowing through the turbine on the turbine, remains almost the same for each turbine.

12. The method according to claim 2, wherein the active blade sections are chosen so that a thrust imposed from steam flowing through the turbine rotor, remains almost the same for each turbine.

13. A method for manufacturing steam turbines, the method comprising the steps of:
manufacturing a plurality of at least one of the same housings and turbine rotors in stock; and
defining an active blade section of at least one turbine stage separately for each turbine, according to a flow profile and pressure specification for the respective turbine.

14. The method according to claim 13, whereby for all turbine stages, the active blade sections are adapted to meet the particular specifications for each turbine, respectively.

15. The method according to claim 13, wherein the active blade sections are adjusted by predetermining the blade angle for each stage.

16. The method according to claim 13, wherein the steam turbines are at least one of high pressure and medium pressure turbines.

17. The method according to claim 13, wherein the turbines using at least one of the same housing and turbine rotor differ in a range of 200 MW to 400 MW electrical output.

18. The method according to claim 13, wherein the active blade sections are chosen so that a thrust imposed from steam flowing through the turbine on the turbine, remains almost the same for each turbine.

19. The method according to claim 13, wherein the active blade sections are chosen so that a thrust imposed from steam flowing through the turbine rotor, remains almost the same for each turbine.
